(19) United States
(12) Patent Application Publication
(10) Pub. No.: US 2006/0106597 A1
(43) Pub. Date: May 18, 2006

(54) System and method for low bit-rate compression of combined speech and music

(76) Inventor: Yaakov Stein, Tel Aviv (IL)

Correspondence Address: KATTEN MUCHIN ROSENMAN LLP, 575 MADISON AVENUE, NEW YORK, NY, 10022-2585, US

(21) Appl. No.: 10/529,280

(22) PCT Filed: Sep. 24, 2003
(86) PCT No.: PCT/IB03/04856

§ 371 Date: Aug. 24, 2005

Related U.S. Application Data
(60) Provisional application No. 60/413,051, filed on Sep. 24, 2002.

(51) Int. Cl. G10L 21/00

(52) U.S. Cl. 704/203

(57) ABSTRACT

A system and method of compressing audio signals (110, 116, 130, 136, 140, 146) which simultaneously contain speech (110, 116), music (130, 136, 140, 146) and possibly other audio in such fashion as to reduce the required bandwidth or storage capacity. Audio (110, 116, 130, 136, 140, 146) is transmitted as simultaneous but separate streams of speech audio (110, 116) and music (or other non-speech) audio (130, 136, 140, 146), as well as other streams such as video (210, text (120, 220), computer graphics (230), etc. By keeping the music (130, 136, 140, 146) separate from the speech (110, 116), each can be maximally compressed. By synchronizing these streams (110, 116, 130, 136, 140, 146, 210, 216, 220, 230), the desired combination can be recreated at the receiver with the user being unaware of the separation. Instead of analog or digital mixing of the music or other non-speech audio (130, 136, 140, 146) with the speech audio (110, 116) to create a composite audio stream (110, 116, 130, 136, 140, 146), the streams are kept logically separate, and, thus, can be optimally compressed using existing technologies.

### PRIORITY INFORMATION

This application claims priority from U.S. Ser. No. 60/413,051 filed Sep. 24, 2002 entitled “Method for Low Bit Rate Compression of Combined Speech and Music”, which is hereby incorporated by reference.

### TECHNICAL FIELD

The present invention relates generally to the compression of audio signals comprising both speech and music for transmission over digital networks. More specifically, the present invention is a method of compressing audio signals that simultaneously contain speech, music and possibly other audio in such fashion as to reduce the required transmission bandwidth or storage capacity.

### BACKGROUND ART

Television and radio programming, such as news and talk shows, were once universally transmitted in analog form using radio broadcasting but are now increasingly being sent in digital format over cable-TV, cellular and Internet infrastructures. Television programming comprises two distinguishable components, the wider bandwidth (or higher bit-rate) video component containing a succession of color raster images, and the audio component that contains speech, music, and miscellaneous special audio sounds. The video and audio components are combined to form a single analog or digital transmitted signal, and thus the time relationship between these components is maintained. If new information (e.g., subtitles or additional audio channels) is required to be transmitted, this information is added to either the video or audio component before these components are combined to form the transmitted signal.

The aforementioned transmitted signal is of constant bandwidth or bit-rate, in the analog or digital case respectively, and this required bandwidth or bit-rate must be allocated in the transmission medium for the signal to be properly received. Even if the image were to remain static or the audio to become silent, this bandwidth or bit-rate must be maintained. Hence, given the overall bandwidth, and taking various overhead factors into account, the number of broadcast channels is limited.

Over the years, the number of available broadcast channels has increased faster than the availability of bandwidth and bit-rate, leading to a preference for both more efficient digital methods over the older analog ones and to compression techniques that reduce the bit-rate required for each digital broadcast signal. These compression techniques operate on either the video component or the audio component of the transmitted signal; if either of these components is itself composed of several identifiable parts, such as the audio comprising speech and music or the video containing both images and subtitles, that aggregate component is conventionally compressed.

Sophisticated audio compression techniques achieve their bit-rate reduction by exploiting detailed characteristics of the sound to be compressed. For example, state-of-the-art speech compression techniques (such as linear predictive coding (LPC) and its derivatives: Code Excited Linear Prediction (CELP), Mixed Excitation Linear Prediction (MELP), and “waveform interpolation”) assume that the sounds were generated by a system similar to the biological structure of lungs, vocal chords, vocal and nasal tract, etc. Hence, a technique tailored to efficiently compress audio containing speech will not generally perform well on music, and vice versa. Complex aggregate signals have little identifiable structure and, consequently, can not be significantly compressed.

Cellular telephony has become extremely popular worldwide, and is being increasingly integrated into various other applications. Presently, it is being used to provide news and information in both text and audio. In the future the cellular system may be used for full-featured broadcasting of news and similar programs with both video and audio streams transferred over the cellular infrastructure and displayed on the cellular telephone. The fact that such broadcasts can be supplied “on demand” and can be charged “per use” makes them popular with both users and providers. This development raises technological problems due to both the bandwidth limitations of the present generation air interfaces and to the limited audio and video capabilities of the small format handset.

There are at present a large number of “Internet radio stations” providing broadcast programming to world-wide audiences. The Internet is, in theory, capable of carrying on-demand broadcasts of news and entertainment programming with high video resolution and audio quality. However, many Internet users are still connecting over dial-up connections with limited bandwidth, and thus, are not capable of enjoying true broadcast-quality programming.

Both of the aforementioned applications could become more universally available if appropriate low bit-rate compression techniques were available. A full-featured solution would need to handle video, speech audio, music audio, text (such as subtitles), and perhaps other data streams simultaneously—compressing all of them, so that the sum of all their data rates remains under the maximal channel capacity, and keeping all in synchronization to each other.

Video compression schemes that can reduce the bandwidth required for the video transport to acceptable levels are known. MPEG2 can compress a full-size video stream to as low as 1.5 Mbps, while small format—black and white, 10 frame per second video streams of the type that could be displayed on cellular telephones—can be compressed to 16 Kbps or less.

Likewise, CELP speech compression techniques of acceptable computational complexity and quality that operate at or below 8 Kbps have become standard, low bit-rate compression schemes, such as those based on waveform interpolation, that require 4 Kbps or less are becoming possible. Even higher compression of speech information may be achieved by sending only the text to be spoken and relying on text-to-speech conversion methods. This technology, while not yet sufficient for professional applications, is acceptable for casual or hobby purposes.

In addition to speech audio, entertainment broadcasts employ music and other sound effects. For example, news broadcasts usually start with a distinctive theme song, which fades out before the first item is read. Thereafter, various features are cued by recognizable themes (e.g., sports will have a short sports related music, criminal news might have a police siren wailing, political gossip may have the country's national anthem, etc.). In drama broadcasts, soft background music is universally used for dramatic effect such as creating tension or indicating emotional state.

As discussed above, in traditional radio/television broadcasting and movie production, the speech and music audio are mixed, by either analog or digital means, to create a composite audio stream, which is then stored and/or transmitted or first placed on the same medium as a video stream and then broadcast. This is done to ensure the proper synchronization of these components. For example, if video and speech components lose synchronicity, then lack of “lip sync” becomes troublesome. Similarly, if music and speech lose synchronicity, then the music may lose the proper “timing” with respect to the dialog and, in extreme cases, may even drown out important utterances.

Music audio requires a higher bandwidth to transmit than compressed speech, and its compression relies on significantly different coding technologies. Typically, music is sampled at over 40 kilo-samples per second and compressed to 32 Kbps or higher. This is four times the rate of standard speech compressions and eight times that of the newer techniques.

Music can, in exceptional cases, be compressed further. For example, if the music component consists of a single instrument with little background noise, then using models that exploit the instrument's sound creation physics (in a manner similar to the exploitation of the vocal tract's physics for speech) can lead to low bit-rate representations. Music that is created by electronic and/or computerized means can take up considerably less bandwidth and storage. For example, the Musical Instrument Digital Interface (MIDI) specification allows very low bit-rate transfer of multi-instrument music pieces. In addition, there are several formats that effectively represent traditional music scores in linear format, which can be used for maximal compression. When several instruments are involved, and likewise when speech and music are mixed, compression of the combined signals to rates significantly lower than 32 Kbps, becomes difficult.

The following references provide a general teaching in encoding signals that contain both speech and music. But, they fail to teach simultaneous but separate encoding of spectrally intertwined speech and music components to achieve optimal compression.

The patent to Ubale et al. (U.S. Pat. No. 5,778,335) provides for a method and apparatus for efficient multiband CELP coding of wideband speech and music. A speech/music classifier categorizes the input as being more speech-like or more music-like and, based on this classification, modifies the parameters of the coding scheme employed. The compressed signal contains a signal type field, which is required for the decoder to select the proper decompression scheme.

The patent to Wuppermann (U.S. Pat. No. 5,982,817) provides for a transmission system utilizing different coding principles. Described within is a method for coding audio that may contain speech and music components, but that does not attempt to explicitly treat these components. Instead, this method utilizes two general-purpose encoders in series, in order to improve the resulting quality.

The patent to Cohen et al. (U.S. Pat. No. 6,134,518) provides for digital audio signal coding using both a CELP Coder (optimal for speech) and a Transform Coder (for music). Described within is a method for initially classifying the input into one of two types (in one embodiment, music or speech), and then compressing an audio signal using the more appropriate of the two encoding schemes.

The patent to Murashima (U.S. Pat. No. 6,401,062 B1) provides for an apparatus for encoding and apparatus for decoding speech and musical signals. Discussed within is a method for encoding audio that contains speech and music components, but that does not attempt to explicitly treat these components. A standard CELP encoder is used in conjunction with a FFT-based band-splitting circuit to divide the audio frequency spectrum into multiple bands. Separate pulse excitations can be provided for each frequency-band, thus implicitly enabling modeling of both speech and music spectra.

The patent to Hirayama et al. (EP 0790743 A2) provides for an apparatus for synchronizing compressed signals. Described within is a method for keeping digital video and audio streams synchronized by aligning time durations of the respective packets and inserting a sequence number into the audio packet. Other data, for example subtitles, can be similarly treated, but the separation between the compressed streams is based on external factors, and is not employed to improve the compression.

Previous inventors, such as Cohen et al. in the above-mentioned U.S. Pat. No. 6,134,518, and Tancerel et al. from the University of Sherbrooke in “Combined Speech and Audio Coding by Discrimination” have considered the case that the audio component consists, at any instant, of either voice or music, but not both. In such a case, it may be possible to discriminate between time intervals wherein the audio contains voice and those wherein it contains music. When voice has been detected, an appropriate speech compression technique such as CELP can be employed, while when it has been decided that music is present, a compression suitable to music, such as a DCT based transform method, will be utilized. The discrimination between the two cases may be based on an autocorrelation criterion, and the reliability of its decisions is vital for the proper functioning of the combined method.

Whatever the precise merits, features and advantages of the above cited references, they do not achieve or fulfill the purposes of the present invention.

### DISCLOSURE OF INVENTION

The present invention proposes a method and a system for low bit-rate compression of audio simultaneously comprising speech and music for broadcast over a communications channel. Such communications channels are often limited in bandwidth as is the case for cellular phone and dial-up Internet connections in particular.

In the present invention, information to be transmitted is comprised of different components, which are separately compressed, synchronized, and transmitted. For example, the present invention allows for the simultaneous, but separately compressed, transmission of speech audio, music (or other non-speech) audio, and other streams including, but not limited to: video, text, or computer graphics. By keeping the music separate from the speech or video separate from overlaid text, each can be maximally compressed. By synchronizing these streams the desired combination can be recreated at the reception end with the user remaining unaware of the separation. For example, the reception end would consist of an end-device such as, but not limited to, a user's phone or computer (hereafter terminal).

The production of a news or entertainment broadcast using this technique is similar to present day techniques. However, instead of analog or digital mixing of the music or other non-speech audio with the speech audio to create a composite audio stream, the streams are kept logically separate.

In addition to the main benefit of enabling low bit-rate transmission, the separation of the streams has additional advantages. Such streams are independently generated, stored and transmitted, so that speech languages could be exchanged without having to change the video or music, or music (e.g., national anthems) could be exchanged without affecting video or speech. These alternative streams could be made available for the user to choose in real-time. Furthermore, relative volume of music versus speech could now be set by the user, allowing hearing-impaired users to remove the music stream, while music lovers could increase the music level.

In a preferred embodiment, the present invention provides a system for transmission of both speech and music in maximally compressed format, i.e., speech as text and music as MDI or a similar artificial format. For “radio” type broadcasts, these would be the constituent streams, while for “television” type broadcasts compressed video would be sent as well. Additional streams, including, but not limited to, sound effects, text (e.g., subtitles, Karaoke, etc.), and computer graphics could be sent as well. All streams are sent separately but with synchronizing mechanisms included which enable proper reconstruction. At the user's phone or computer terminal each stream is interpreted by its appropriate interpreter.

In an alternative embodiment, the present invention, additionally, allows the speech to be acquired from an actual human speaker and compressed using a low bit-rate speech encoder. At the user's terminal the speech is reconstructed by the appropriate decompression, the other streams also being reconstructed by their appropriate interpreters with proper synchronization maintained.

In a third embodiment, the speech is acquired as in one of the previous embodiments, but the music is acquired as audio and either compressed or converted by automatic means to MIDI or similar artificial format. At the user's terminal, the music is reconstructed by the appropriate decompression or interpreter and played out in synchronization with a reconstructed speech signal.

In another embodiment, the audio input is composite speech and music audio. By using signal separation algorithms (which may rely on the original signal having been recorded on two microphones which contain two different combinations of the two signals or may be single channel), the speech and music audio signals are separated, and the third embodiment is followed.

In yet another embodiment, the present invention provides a system for transmission of audio and as well as video with overlaid subtitles, icons, special symbols and computer graphics for “television” type broadcasts. The video stream before combination with the other information types may be compressed using efficient video compression techniques (e.g., MPEG) while the subtitles, icons, symbols, and computer graphics are sent separately using the most efficient mechanisms. Synchronizing mechanisms are utilized to enable proper reconstruction. At the receiver, the video is decompressed, and the other information sources are overlaid, resulting in a composite video being displayed on the cellular phone display or computer screen. The user may choose which of the information sources is enabled.

### BRIEF DESCRIPTION OF DRAWINGS

FIG. 1 illustrates the transmission functions of the present invention.

FIG. 2 depicts the corresponding reception functions.

FIG. 3 depicts the embodiment wherein signal separation must be performed.

### DESCRIPTION OF THE PREFERRED EMBODIMENTS

While this invention is illustrated and described in preferred embodiments, the invention may be implemented in many different configurations and forms. While preferred embodiments are depicted in the drawings and herein described in detail, it is the understanding that the present disclosure is to be considered as an exemplification of the principles of the invention and the associated functional specifications for its implementation and is not intended to limit the invention to the embodiment illustrated. Those skilled in the art will envision many other possible variations within the scope of the present invention.

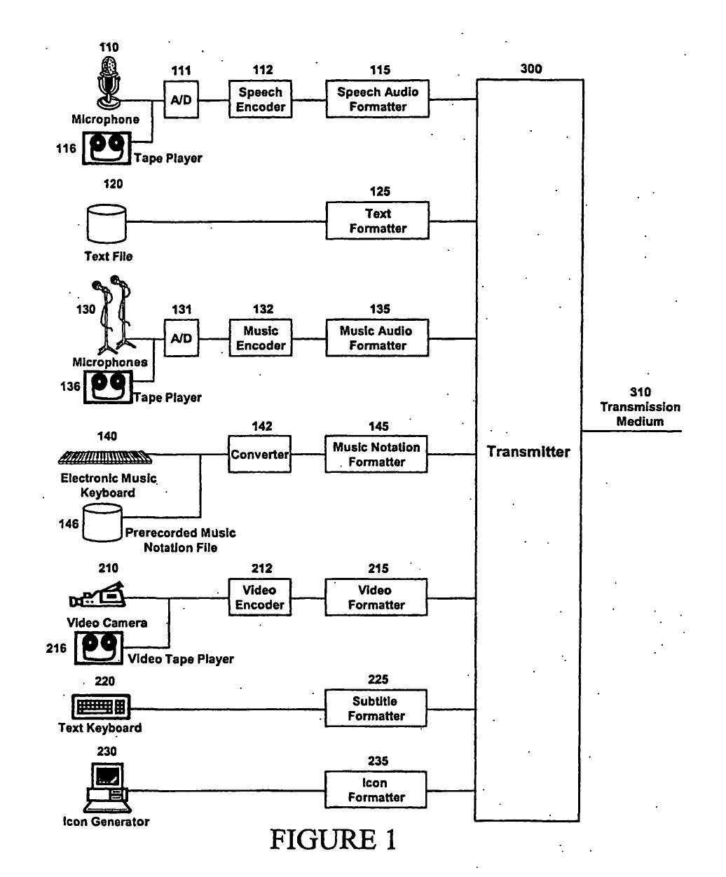

FIG. 1 illustrates examples of the transmission function with multiple combinations of inputs. In FIG. 1, a voice signal is captured by microphone 110 and converted into a digital signal by the analog-to-digital converter 111. Alternatively, or in addition, the analog voice signal may have been prerecorded and is played back by tape player 116 and similarly converted by analog-to-digital converter 111. The uncompressed digital speech is compressed by speech encoder 112. The speech encoder 112 may be, for example, a conventional CELP or waveform interpolation encoder.

The frames of encoded speech are transformed into a format suitable for transmitter 300. For example, the encoded speech signal is encapsulated into packets (by speech audio formatter 115) for transport over packet switched networks or converted into serial bitstreams (by speech audio formatter 115) for transport over synchronous networks. Speech audio formatter 115 is also responsible for embedding any synchronization information that will be required later for proper synchronization of the various streams. Examples of synchronization information include, but are not limited to timestamps, sync labels, or media synchronization tags (such as SMIL). The output of the speech audio formatter 115 is fed to transmitter 300.

Text input may also be provided to the transmitter 300. The text input, in one embodiment, is to be converted at a receiver into speech audio using text-to-speech synthesis. As shown in the example of FIG. 1, the input text is retrieved from text file 120 and input directly into text formatter 125. Text formatter 125, similar to speech audio formatter 115, is responsible for: (a) ensuring that the text is in a format suitable for transmission by transmitter 300; and (b) embedding synchronization information. Synchronization information includes, but should not be limited to, timestamps, sync labels, or text flow control. In this latter method, the amount of text forwarded at each time is limited based on the transmission status of the other streams.

Music acquired by a source such as microphones 130, or played back by tape player 136, is digitized by analog-to-digital converter 131 and compressed by music encoder 132. Music encoder 132 may be, for example, a transform-based encoder, for example MPEG-audio or Dolby® AC-3. The digital representation of the music is formatted by music audio formatter 135, which supports all the functions of the previously described formatters (i.e., speech audio formatter 115 and text formatter 125). The output of the music audio formatter 135 is fed to transmitter 300.

Music may be generated in real-time, by a source such as an electronic music keyboard 140, or may have been generated by such a device in the past and captured for playback from a pre-recorded music notation file 146. This file, typified by MIDI files, usually contains time-stamped key presses and releases, as well as keyboard status information. The output of the electronic music keyboard may optionally be converted into another notation by converter 142. For example, the output of the device is converted (via converter 142) to a notation directly representing music staff notation. In either case, the succinct representation of music is formatted by an appropriate formatter, which adds all synchronization information, and is delivered to the transmitter 300.

It is to be understood that not all of the audio inputs herein depicted must be present in implementations of the present invention. Indeed, it is sufficient for any single voice audio source, such as that from microphone 110, and any single music audio source, such as that from electronic music keyboard 140, to be present for the present invention to provide benefits as compared with the prior art. Also it is understood that any combination of the audio inputs may be included. For example, both speech inputs from a tape player and from a microphone can be included.

In addition to all the audio streams already discussed, there are additional input streams in those cases where video is required to be transmitted. Video camera 210 acquires moving images, which are transferred to a video encoder 212, which compresses the video into a constant or variable bit-rate stream. Examples of video compression techniques that may be used include motion-JPEG, MPEG and H.261 (px64). Alternatively, or in addition, prerecorded video played back by video tape player 216 can be input to the video encoder. In either case, the compressed video stream is formatted by video formatter 215 that adds any required synchronization information. The formatter's output is delivered to the transmitter 300.

Another source of information to be eventually displayed on the user's screen is text, such as subtitles or scrolling news updates that is not intended to be converted into speech, but rather displayed in visual form at the receiver. These are input from a source, such as a text keyboard 220, or from stored files and formatted by formatter 225, in a manner similar to that discussed for text formatter 125.

Finally, any non-text symbols to be displayed on the user's screen, such as overlays indicating the transmitting station's identity, icons distinguishing commercial content, and warning signs signifying that parental guidance is suggested, are generated by icon generator 230. These messages are formatted by icon formatter 235 and delivered to transmitter 300. Icon formatter 235, also, adds any required synchronization information. Static graphics, encoded as bit-maps, or compressed into various compression formats (such as jpg, gif, tiff, etc.), or encoded display-list formats (such as NAPLPS, GKS, PHIGS, VML, etc.) may be treated in the same fashion as non-text symbols, which may hamper synchronization. Dynamic graphics, e.g. dynamic gif, are usually sequences of static graphics, but may have internal timers, which make it difficult to synchronize them as required.

Transmitter 300 multiplexes all of its constituent inputs and places the result on physical transmission medium 310. This medium may be wireless, as in the case of cellular telephone networks, or cable-based, as in the case of Internet broadcasting.

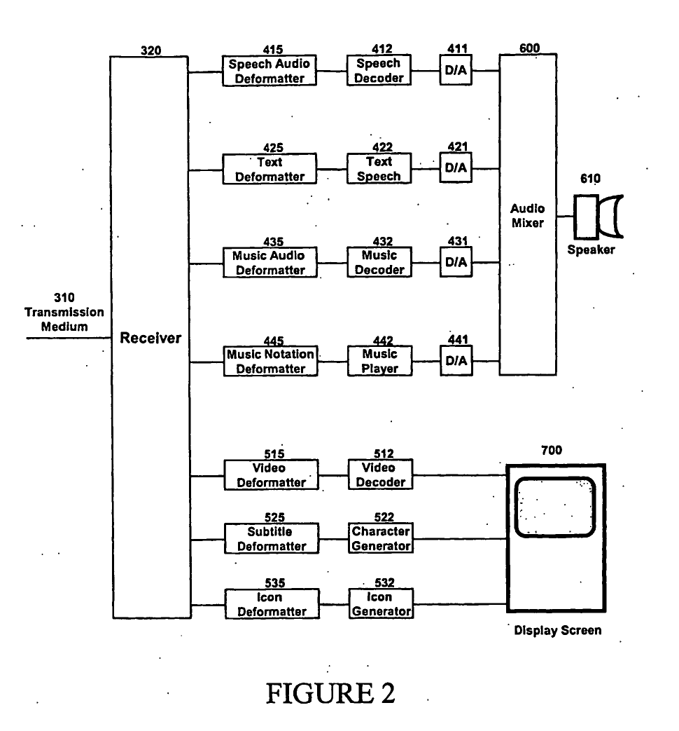

FIG. 2 illustrates examples of the reception function with multiple combinations of received information being decoded and formatted to form outputs. In FIG. 2, receiver 320 recovers, from physical medium 310, the multiplexed transmission from transmitter 300. Then, receiver 320 demultiplexes the constituents and outputs each to its appropriate deformatter for further processing. The deformatters are responsible for maintaining synchronization, based on the synchronization information embedded in each demultiplexed stream and based on the system clock information provided by the receiver 320.

Speech streams that originated from microphone 110 or pre-recorded audio 116 are deformatted and synchronized by deformatter 415 and then decompressed by speech decoder 412, which must match speech encoder 112 (of FIG. 1). The output from the deformatter 415 is then converted to an analog signal by digital-to-analog converter 411 and delivered to audio mixer 600.

Text streams that were formatted by text formatter 125 (of FIG. 1) are deformatted by deformatter 425 and input to text-to-speech converter 422. The user is able to adjust text-to-speech parameters (such as male/female voice, reading speed, etc.). The digital audio output of the text-to-speech converter is converted to analog by D/A 421 and delivered to audio mixer 600.

Compressed music audio that was formatted by formatter 135 (of FIG. 1) is deformatted and synchronized by deformatter 435, and the resulting digital information is decompressed by music decoder 432, which matches music encoder 132 (of FIG. 1). The decoded output is then converted to an analog format by digital-to-analog converter 411 and delivered to audio mixer 600.

Music notation streams that were formatted by formatter 145 (of FIG. 1) are deformatted and synchronized by deformatter 445 and the resulting digital information delivered to an appropriate player (e.g., MDI player). This player provides digital audio which must be converted to analog format by D/A 441 and delivered to the audio mixer.

Audio mixer 600 has individually adjustable gains for each of its inputs, which may be adjusted by the user. The mixer delivers its output to speaker 610, which may be the built-in speaker in a cellular phone, or a higher quality speaker system connected to an Internet workstation.

While the embodiments herein depicted and discussed utilize an analog audio mixer to combine the various types of audio, it should be noted that weighted digital mixing followed by a single digital-to-analog converter would be appropriate as well. In addition, mixed cases are possible. For example, the music notation player 445 may output analog audio directly to the mixer while the decompressed audio from 412 is fed to digital-to-analog converter 411.

In those cases where video is transmitted, the additional input streams must be handled as well. Video deformatter 515 deformats and synchronizes streams formatted by formatter 215. The resulting compressed video is decompressed by video decoder 512, which must match video encoder 212 (of FIG. 1). The uncompressed video is delivered to screen 700 for display.

Subtitles and similar text that was formatted by formatter 225 is deformatted by deformatter 525. The resulting synchronized character stream is input to character generator 522 which overlays the characters on display screen 700.

Icons and similar special symbols that were formatted by formatter 235 (of FIG. 1) are deformatted by deformatter 535. The resulting graphical information is input to icon generator 532 which overlays the desired symbols on display screen 700.

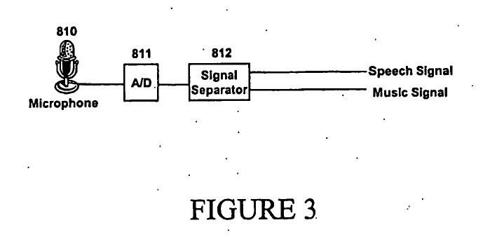

FIG. 3 illustrates another embodiment wherein the speech and music signals are not initially separate streams. In FIG. 3, microphone 810 captures a combined speech and music signal, which after conversion to digital form by analog-to-digital converter 811 is input to signal separator 812 that separates the speech signal from the music signal. The separated signals are then processed as in an embodiment such as that described in FIG. 1.

Other types of audio or video streams are possible and would still be within the spirit and scope of the present invention. For example, were one to have specific models that efficiently compress the sounds of various instruments in an orchestra, the separate acquisition and transmission of these instruments as digital streams, their decompression, and the subsequent reconstruction of the overall orchestral sound, would be in the spirit of the present invention.

Although we specifically addressed the broadcast application, the invention could also be used for two-way transmission of audio containing speech and music, or for multiple participant conferencing. In addition, although the above description specifically dealt with compression for the purpose of conservation of network resources upon transmission of the combined stream, the invention could equally well be used to conserve storage resources when the combined streams need to be stored for later play-back.

A system and method has been shown in the above embodiments for the effective implementation of efficient compression of audio consisting of both speech and music. The essence of the method is the simultaneous but separate transmission of speech and music (or other non-speech) audio, as well as other streams such as video, text, computer graphics, etc. By keeping the music audio separate from that of the speech, each can be maximally compressed. By synchronizing these streams, the desired combination can be recreated at the reception end, such as on a user's phone or computer (hereafter terminal), with the user unaware of the separation.

Furthermore, the present invention could be implemented as a computer program code based product, which is a storage medium having program code stored therein that can be used to instruct a computer to perform any of the methods associated with the present invention.

Implemented in such computer program code based products are software modules for: (a) controlling the capture and conversion of audio signals into digital format; (b) encoding digital speech signals using a speech compression algorithm; (c) transforming the encoded speech signal into a format suitable for broadcast via a transmitter and embedding synchronization information associated with the speech component; (d) encoding digital music signals using a music compression algorithm; (f) transforming the encoded music signal into a format suitable for broadcast via the transmitter and embedding synchronization information associated with the music component; and (g) multiplexing the outputs of steps (c) and (f) for broadcast over a broadcast channel.

### CONCLUSION

The present invention provides a system and method for delivery of speech and music over a network which optimally utilizes network resources by separately compressing said speech and music signals using encoders optimized for each and combining said speech and audio signals at the receiver. In another embodiment, the present invention provides delivery of speech and music for news or entertainment broadcast purposes. Also, the system and method can provide news or entertainment programming on-demand. Alternatively, the news or entertainment programming may be provided on a pay-per-use basis or in a combination of services. The present invention also provides for a system and method that allows for the delivery of text data and performs text-to-speech conversion at the receiver. In another embodiment, the present invention provides delivery of music notation data and creates music by utilizing an appropriate player at the receiver. In yet another embodiment, the present invention optionally provides delivery of video content in addition to the audio content. The embodiment may further deliver text, such as subtitles, to be overlaid on the video. The system may also deliver graphic data, such as station identification, to be overlaid on the video.

While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by type of content being transmitted, type of synchronization information, type of encoder, type of decoder, source of content, software/program, computing environment, or specific computing hardware. The above enhancements may be implemented in various computing environments. For example, the present invention may be implemented on a conventional personal computer, multi-nodal system (e.g., LAN) or networking system (e.g., Internet, WWW, wireless web). All programming and data related thereto may be stored in computer memory, static or dynamic, and may be retrieved by the user in any of: conventional computer storage, display (i.e., CRT) and/or hardcopy (i.e., printed) formats. The programming of the present invention may be implemented by one of skill in the art of digital signal processing.

1. A system providing low bit-rate compression of data comprising speech and music components for transmission, over a network, said system comprising:
a. a speech encoder encoding said speech component via a first encoding algorithm, transforming said encoded speech signal into a format suitable for transmission, and embedding synchronization information associated with said speech component;
b. a music encoder encoding said music component via a second encoding algorithm, said second encoding algorithm different from said first encoding algorithm; transforming said encoded music signal into a format suitable for transmission; and embedding synchronization information associated with said music component; and
c. a multiplexer multiplexing said outputs of said speech encoder and said music encoder for transmission over said network,
wherein said first and second encoding algorithms are chosen to allow for low bit-rate compression of speech and music respectively.

2. A system as per claim 1, wherein said data is a composite of said speech and music components and said system further comprises a signal separator, said signal separator separating said speech and music components from said composite.

3. A system as per claim 1, wherein said data further comprises a text component, a video component, and a graphics component, said system further comprising:
a text formatter transforming said text component into a format suitable for transmission and embedding synchronization information associated with said text component;
a video encoder encoding said video component via a third encoding algorithm, said third encoding algorithm different from said first and second encoding algorithms; transforming said encoded video signal into a format suitable for transmission; and embedding synchronization information associated with said video component;
a graphics encoder encoding said graphics component via a fourth encoding algorithm, said fourth encoding algorithm different from said first, second, and third encoding algorithms; transforming said encoded graphics into a format suitable for transmission; and embedding synchronization information associated with said graphics component; and
said multiplexer in (c) additionally multiplexing the output of said text formatter, said video encoder, and graphics encoder.

4. A system as per claim 3, wherein said text component corresponds to subtitles associated with said video components.

5. A system as per claim 1, wherein audio volumes associated with said speech component and said music component are modifiable relative to each other.

6. A system as per claim 1, wherein said speech encoder is a LPC, MELP, CELP, or waveform interpolation encoder.

7. A system as per claim 1, wherein said speech encoder is used in conjunction with a speech-to-text converter, and
said speech-to-text converter converting said speech component to a text component; and
said speech encoder encoding said text components and formatting said encoded text into a format suitable for transmission.

8. A system as per claim 1, wherein said embedded synchronization information is any of the following: timestamps, synchronization labels, media synchronization tags, synchronizing tokens, or wait-on-event commands.

9. A system as per claim 1, wherein said music encoder is a MDI-encoder or linear musical score notation.

10. A system as per claim 1, wherein said music encoder is a transform-based encoder.

11. A system as per claim 1, wherein said network is any of the following: local area network, wide area network, the Internet, cellular network, storage network, or wireless network.

12. A system providing low bit-rate compression of audio comprising speech and music components for transmission over a communication channel, said system comprising:
a. a first analog-to-digital converter converting said speech component into a digital speech signal;
b. a speech encoder encoding said digital speech signal via a first encoding algorithm;
c. a speech audio formatter transforming said encoded speech signal into a format suitable for transmission and embedding synchronization information associated with said speech component;
d. a second analog-to-digital converter converting said music component into a digital music signal;
e. a music encoder encoding said digital music signal via a second encoding algorithm, said second encoding algorithm different from said first encoding algorithm;
f. a music audio formatter transforming said encoded music signal into a format suitable for transmission and embedding synchronization information associated with said music component; and
g. a multiplexer multiplexing said outputs of said speech audio formatter and said music audio formatter for transmission over said channel.

13. A system as per claim 12, wherein said speech encoder is a LPC, MELP, CELP or waveform interpolation encoder.

14. A system as per claim 12, wherein said music encoder is a MDI-encoder or linear musical score notation.

15. A system as per claim 12, wherein said embedded synchronization information is any of the following: timestamps, synchronization labels, media synchronization tags, synchronizing tokens, or wait-on-event commands.

16. A system as per claim 12, wherein said music encoder is a transform-based encoder.

17. A method to encode audio for transmission over a communication channel, said audio comprising speech and music components, said method comprising:
a. converting said speech component into a digital speech signal;
b. encoding said digital speech signal via a first encoding algorithm;
c. transforming said encoded speech signal into a format suitable for transmission and embedding synchronization information associated with said speech component;
d. converting said music component into a digital music signal;
e. encoding said digital music signal via a second encoding algorithm, said second encoding algorithm different from said first encoding algorithm;
f. transforming said encoded music signal into a format suitable for transmission and embedding synchronization information associated with said music component; and
g. multiplexing said outputs of steps (c) and (f) for transmission over said channel.

18. A method as per claim 17, wherein said embedded synchronization information is any of the following: timestamps, synchronization labels, media synchronization tags, synchronizing tokens, or wait-on-event commands.

19. An article of manufacture comprising a computer usable medium having computer readable program code embodied therein for decoding transmitted data received over a communication channel, said transmitted data comprising a plurality of components, each component encoded via a separate encoding algorithm to provide low bit-rate compression, said medium comprising:
a. computer readable program code aiding in receiving said transmitted data received over said communication channel;
b. computer readable program code de-multiplexing said data into a plurality of components, said components comprising at least a speech component and a music component;
c. computer readable program code decoding said speech component via a first decoding algorithm; and
d. computer readable program code decoding said music component via a second decoding algorithm, said second decoding algorithm different from said first decoding algorithm.

20. An article of manufacture as per claim 19, wherein said plurality of components additionally comprises a video component, a text component, and a graphics component, said medium further comprising:
a. in addition to de-multiplexing said data into speech and music component, computer readable program code de-multiplexing said video component, said text component, and said graphics component
b. computer readable program code formatting said text component;
c. computer readable program code decoding said video component via a third decoding algorithm, said third decoding algorithm different from said first and second decoding algorithm; and
d. computer readable program code decoding said graphics component via a fourth decoding algorithm, said fourth decoding algorithm different from said first, second, and third decoding algorithm.

21. A method encoding data for transmission over a communication network, said data comprising speech, music, video, text, and graphic components, said method comprising the steps of:
a. encoding said speech component via a first encoding algorithm;
b. transforming said encoded speech signal into a format suitable for transmission and embedding synchronization information associated with said speech component;
c. encoding said music component via a second encoding algorithm, said second encoding algorithm different from said first encoding algorithm;
d. transforming said encoded music signal into a format suitable for transmission; and embedding synchronization information associated with said music component;
e. encoding said video component via a third encoding algorithm, said third encoding algorithm different from said first and second encoding algorithms;
f. transforming said encoded video signal into a format suitable for transmission and embedding synchronization information associated with said video component;
g. transforming a text component into a format suitable for transmission and embedding synchronization information associated with said text component;
h. encoding said graphics component via a fourth encoding algorithm, said fourth encoding algorithm different from said first, second, and third encoding algorithm;
i. transforming said encoded graphics signal into a format suitable for transmission; and embedding synchronization information associated with said graphics component; and
j. multiplexing said outputs of steps (b), (d), (f), (g), and (i) for transmission over said network,
wherein said first, second, third, and fourth encoding algorithms are chosen to allow for low bit-rate compression of speech, music, video, text, and graphics respectively.

22. A method as per claim 21, wherein said embedded synchronization information is any of the following: timestamps, synchronization labels, media synchronization tags, synchronizing tokens, or wait-on-event commands.

23. A method as per claim 21, wherein said network is any of the following: local area network, wide area network, the Internet, cellular network, storage area network, or wireless network.
